(19) United States
(12) Patent Application Publication
(10) Pub. No.: US 2012/0006077 A1
(43) Pub. Date: Jan. 12, 2012

(54) Detergent feeding apparatus and washing machine having the same

(75) Inventors: Il Ju Mun, Suwon-si (KR); Byung Sang Yun, Yongin-si (KR); Eung Yeoul Yoon, Suwon-si (KR); Kyu Ho Shin, Seoul (KR); Kwang Hyok Park, Suwon-si (KR)

(73) Assignee: SAMSUNG ELECTRONICS CO., LTD., Suwon (KR)

(21) Appl. No.: 13/067,487

(22) Filed: Jun. 3, 2011

(30) Foreign Application Priority Data
Jul. 6, 2010 (KR) 10-2010-0064941

(51) Int. Cl. D06F 39/02; B67D 7/84; B67D 7/64; B67D 7/08

(52) U.S. Cl. 68/17 R; 222/63; 222/333; 222/386

(57) ABSTRACT

A washing machine having a detergent feeding apparatus to stably feed a required amount of liquid detergent based on the amount of laundry in an automated manner. The washing machine includes a cabinet defining an external appearance of the washing machine, a drum placed in the cabinet, a detergent box connected to the drum, a liquid detergent reservoir placed below the detergent box and to store liquid detergent therein, and a detergent feeding apparatus connected to the detergent box and the liquid detergent reservoir and to feed the liquid detergent stored in the liquid detergent reservoir to the detergent box. The detergent feeding apparatus includes a cylinder which the liquid detergent is introduced into or discharged from, and a pressure regulating unit connected to the cylinder and to introduce the liquid detergent into the cylinder or discharge the introduced liquid detergent from the cylinder.

### CROSS-REFERENCE TO RELATED APPLICATIONS

This application claims the priority benefit of Korean Patent Application No. 2010-0064941, filed on Jul. 6, 2010 in the Korean Intellectual Property Office, the disclosure of which is incorporated herein by reference.

### BACKGROUND

1. Field

Embodiments relate to a liquid detergent feeding apparatus of a washing machine to enable automated feeding of a fixed quantity of liquid detergent.

2. Description of the Related Art

A washing machine washes clothes using electric power. Generally, a washing machine includes a cabinet defining an external appearance of the washing machine, a tub provided in the cabinet to store wash water therein, a drum installed in the tub in a rotatable manner, and a motor to rotate the drum.

If the drum is rotated by the motor in a state in which laundry and wash water are placed in the drum, dirt adhered to the laundry is removed as the laundry collides with wash water and the drum.

Detergents used to remove dirt adhered to laundry include powdered detergent and liquid detergent. Recently, liquid detergent has been widely used because liquid detergent is more soluble than powdered detergent and is not scattered and blown off by the wind.

However, if a user inputs an inappropriate amount of liquid detergent during washing based on an arbitrarily determined amount of laundry, i.e. inputs an excessive or insufficient amount of liquid detergent, this may cause damage to laundry, or poor washing of laundry.

For this reason, there is a demand for a detergent feeding apparatus to input or feed an appropriate amount of liquid detergent based on the amount of laundry.

### SUMMARY

Therefore, it is one aspect to provide a washing machine having a detergent feeding apparatus to automatically feed a required amount of liquid detergent based on the amount of laundry.

It is another aspect to provide a washing machine having a detergent feeding apparatus to stably feed an appropriate amount of liquid detergent even after extended use.

It is a further aspect to provide a washing machine having a detergent feeding apparatus to effectively feed liquid detergent.

Additional aspects of the invention will be set forth in part in the description which follows and, in part, will be apparent from the description, or may be learned by practice of the invention.

In accordance with one aspect, a washing machine includes a cabinet defining an external appearance of the washing machine, a drum placed in the cabinet, a detergent box connected to the drum, a liquid detergent reservoir placed below the detergent box and to store liquid detergent therein, and a detergent feeding apparatus connected to the detergent box and the liquid detergent reservoir and to feed the liquid detergent stored in the liquid detergent reservoir to the detergent box, wherein the detergent feeding apparatus includes a cylinder which the liquid detergent is introduced to or discharged from, and a pressure regulating unit connected to the cylinder and to introduce the liquid detergent into the cylinder or discharge the introduced liquid detergent from the cylinder.

The cylinder may further include an inlet connected to the liquid detergent reservoir and an outlet connected to the detergent box.

The inlet and the liquid detergent reservoir may be connected to each other using an introduction hose, and the introduction hose may be provided with an anti-backflow valve.

The outlet and the detergent box may be connected to each other using a discharge hose, and the discharge hose may be provided with an anti-backflow valve.

The pressure regulating unit may include a motor, a rotating plate coupled to a shaft of the motor, a piston to rectilinearly reciprocate in the cylinder, and a connecting rod having one end coupled to the rotating plate and the other end coupled to the piston.

A sealing member may be provided at a front end of the piston to prevent the liquid detergent from entering the pressure regulating unit.

The sealing member may include at least one protrusion to come into contact with an inner circumferential surface of the cylinder.

The pressure regulating unit may include a motor, a first gear coupled to a shaft of the motor, a piston to rectilinearly reciprocate in the cylinder and a second gear coupled to the piston and engaged with the first gear.

The second gear may be integrally formed with the piston.

The washing machine may further include a laundry weight sensor, and a control device to control operation of the motor, the laundry weight sensor may detect the weight of laundry introduced into the drum, and the control device may determine an input amount of liquid detergent based on the weight of laundry detected by the laundry weight sensor and may control revolutions per minute of the motor based on the determined input amount of liquid detergent, so as to feed liquid detergent into the detergent box.

In accordance with another aspect, a detergent feeding apparatus for a washing machine includes a cylinder which liquid detergent is introduced into or discharged from, and a pressure regulating unit connected to the cylinder and to introduce the liquid detergent into the cylinder or discharge the introduced liquid detergent from the cylinder, wherein the pressure regulating unit includes a motor, a rotating plate coupled to a shaft of the motor, a piston to rectilinearly reciprocate in the cylinder and a connecting rod having one end coupled to the rotating plate and the other end coupled to the piston so as to translate rotating motion of the rotating plate into rectilinear reciprocating motion of the piston.

The cylinder may include an inlet through which the liquid detergent is introduced and an outlet through which the liquid detergent is discharged.

The liquid detergent may be introduced into the cylinder through the inlet if the interior pressure of the cylinder is lowered by rearward movement of the piston, and may be discharged from the cylinder through the outlet if the interior pressure of the cylinder is raised by forward movement of the piston.

The inlet or the outlet may be provided with an anti-backflow valve to allow the liquid detergent to move in one direction.

A sealing member may be provided at a front end of the piston to prevent the liquid detergent from entering the pressure regulating unit.

The sealing member may include at least one protrusion to come into contact with an inner circumferential surface of the cylinder.

In accordance with a further aspect, a detergent feeding apparatus for a washing machine includes a cylinder which liquid detergent is introduced into or discharged from, and a pressure regulating unit connected to the cylinder and to introduce the liquid detergent into the cylinder or discharge the introduced liquid detergent from the cylinder, wherein the pressure regulating unit includes a motor, a first gear coupled to a shaft of the motor, a piston to rectilinearly reciprocate in the cylinder, and a second gear coupled to the piston and engaged with the first gear.

The cylinder may include an inlet through which the liquid detergent is introduced, and an outlet through which the liquid detergent is discharged.

The liquid detergent may be introduced into the cylinder through the inlet if the interior pressure of the cylinder is lowered by rearward movement of the piston, and may be discharged from the cylinder through the outlet if the interior pressure of the cylinder is raised by forward movement of the piston.

The inlet or the outlet may be provided with an anti-backflow valve to allow the liquid detergent to move in one direction.

A sealing member may be provided at a front end of the piston to prevent the liquid detergent from entering the pressure regulating unit.

The sealing member may include at least one protrusion to come into contact with an inner circumferential surface of the cylinder.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a perspective view illustrating the interior of a drum washing machine having a detergent feeding apparatus according to an embodiment;

FIG. 2 is a perspective view illustrating the detergent feeding apparatus according to the embodiment;

FIG. 3 is a sectional view of a piston constituting the detergent feeding apparatus according to the embodiment;

FIG. 4 is a sectional view illustrating an initial state of the detergent feeding apparatus according to the embodiment;

FIG. 5 is a sectional view illustrating introduction of liquid detergent into the detergent feeding apparatus according to the embodiment;

FIG. 6 is a sectional view illustrating liquid detergent completely introduced into the detergent feeding apparatus according to the embodiment;

FIG. 7 is a sectional view illustrating discharge of liquid detergent from the detergent feeding apparatus according to the embodiment;

FIG. 8 is a perspective view illustrating a detergent feeding apparatus according to another embodiment; and

FIG. 9 is a flow chart illustrating a procedure of performing washing by determining the feed amount of liquid detergent based on the weight of laundry.

### DETAILED DESCRIPTION

Reference will now be made in detail to an exemplary embodiment, examples of which are illustrated in the accompanying drawings, wherein like reference numerals refer to like elements throughout.

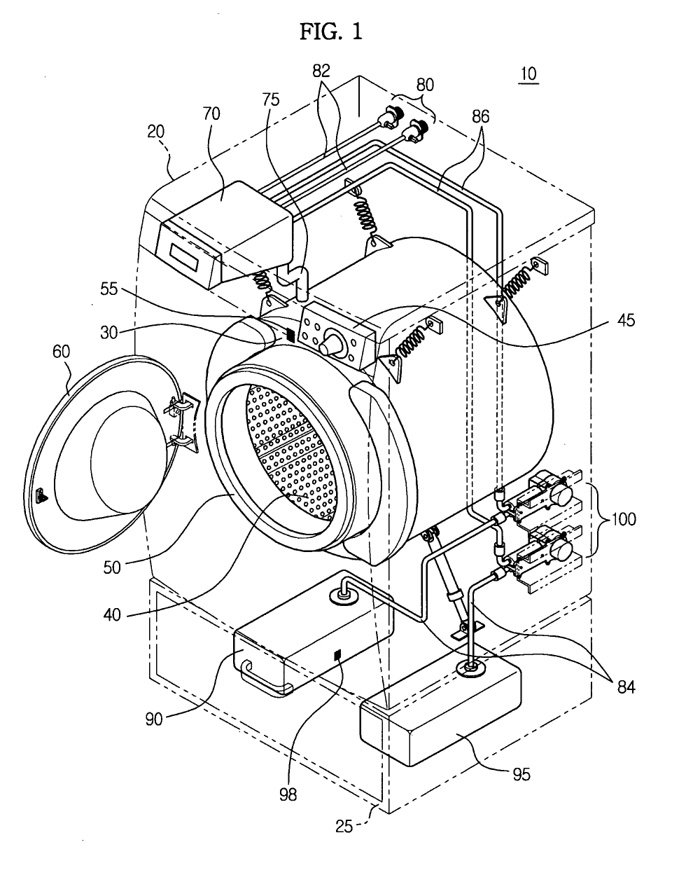

FIG. 1 is a perspective view illustrating the interior of a drum washing machine having a detergent feeding apparatus according to an embodiment.

As illustrated in FIG. 1, the drum washing machine 10 includes a cabinet 20 defining an external appearance thereof, a tub 30 placed in the cabinet 20, and a drum 40 placed in the tub 30 in a rotatable manner. A laundry weight sensor 55 is provided at a front surface of the tub 30.

The cabinet 20 has an opening 50 perforated in the front surface thereof, through which laundry may be input into the drum 40. The opening 50 is opened or closed by a door 60 coupled to the front surface of the cabinet 20.

A control device 45 and a detergent box 70 are placed above the cabinet 20.

The detergent box 70 is connected to a water supply port 80 provided at a rear end of the cabinet 20 using a water feeding hose 82, and receives a required amount of wash water from an external water supply source (not shown). The detergent box 70 is connected to the drum 40 using a wash water feeding hose 75.

The control device 45 controls a variety of drive devices provided in the drum washing machine 10, including a drive device of a detergent feeding apparatus 100 which will be described hereinafter.

A pedestal 25 is located at a lower end of the drum washing machine 10. The pedestal 25 receives a liquid detergent reservoir 90 to store liquid detergent therein to prepare for the case that a user wishes to use liquid detergent and a fabric softener reservoir 95 to store fabric softener therein.

Although the liquid detergent reservoir 90 and the fabric softener reservoir 95 may be provided in the pedestal 25 as described above, the liquid detergent reservoir 90 and the fabric softener reservoir 95 may be provided in a lower region of the cabinet 20 when the pedestal 25 is not used.

Each of the liquid detergent reservoir 90 and the fabric softener reservoir 95 is provided with a sensor 98, which detects a residual amount of liquid detergent or fabric softener, allowing the user to replenish the liquid detergent or fabric softener.

Each of the liquid detergent reservoir 90 and the fabric softener reservoir 95 is connected to the detergent feeding apparatus 100 using introduction hoses 84.

The detergent feeding apparatus 100 is mounted to a sidewall of the cabinet 20.

The detergent feeding apparatus 100 is connected to the liquid detergent reservoir 90 or the fabric softener reservoir 95 using the introduction hose 84, and is connected to the detergent box 70 using a discharge hose 86.

If the detergent feeding apparatus 100 is operated, liquid detergent stored in the liquid detergent reservoir 90 is introduced into the detergent feeding apparatus 100 through the introduction hose 84 and then is introduced into the detergent box 70 through the discharge hose 86. The liquid detergent introduced into the detergent box 70 is mixed with water fed through the water feeding hose 82 and is moved into the drum 40 through the wash water feeding hose 75.

Hereinafter, the detergent feeding apparatus 100 according to the embodiment will be described in detail.

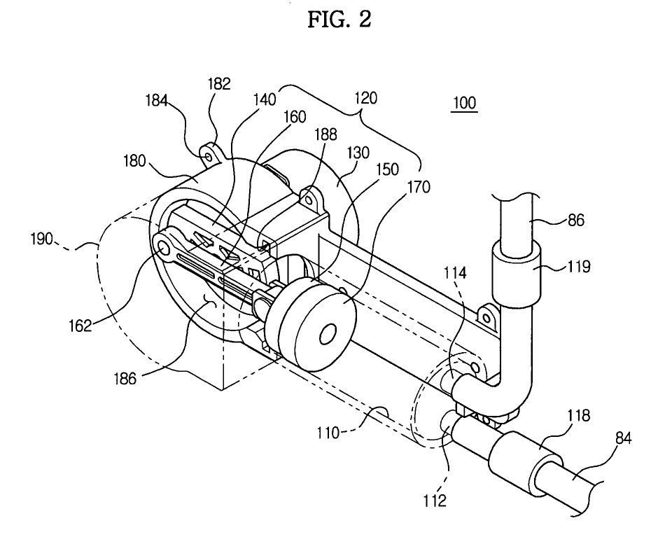

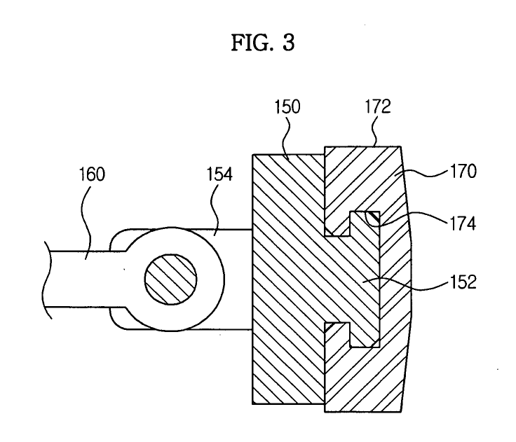

FIG. 2 is a perspective view illustrating the detergent feeding apparatus according to the embodiment, and FIG. 3 is a sectional view of a piston constituting the detergent feeding apparatus according to the embodiment.

As illustrated in FIGS. 2 and 3, the detergent feeding apparatus 100 includes a cylinder 110 and a pressure regulating unit 120. The cylinder 110 and the pressure regulating unit 120 are connected to each other by a case 180.

The cylinder 110 has an approximately cylindrical shape and is made of plastic. The cylinder 110 internally defines a space having a predetermined volume for introduction and discharge of liquid detergent.

The cylinder 110 is provided at one end thereof with an inlet 112 and an outlet 114.

The inlet 112 and the outlet 114 communicate with the cylinder 110 and are configured to extend from the end of the cylinder 110 by a predetermined length. The inlet 112 and the outlet 114 may be integrally formed with the cylinder 110 by injection molding.

The introduction hose 84 and the discharge hose 86 are fitted into the inlet 112 and the outlet 114, respectively, to prevent leakage of liquid detergent in the course of introduction or discharge. In this case, tightening a connection using a clamp (not shown) may further ensure that a liquid detergent leak does not occur.

The introduction hose 84 and the discharge hose 86 are made of, e.g., synthetic rubber or polyurethane. This kind of hose is not folded although it is curved at a predetermined curvature when connected to the inlet 112 or the outlet 114 and thus, has no effect on the flow of liquid detergent passing therethrough.

The introduction hose 84 and the discharge hose 86 may be provided respectively with anti-backflow valves 118 and 119 to prevent backflow of liquid detergent.

The anti-backflow valves 118 and 119 are one-way valves to allow fluid passing therethrough to be moved only in one direction.

The anti-backflow valve 118 provided at the introduction hose 84 serves to allow liquid detergent to be introduced from the introduction hose 84 into the cylinder 110. The anti-backflow valve 119 provided at the discharge hose 86 serves to allow liquid detergent to be discharged from the cylinder 110 into the discharge hose 86.

Although not illustrated, the anti-backflow valves 118 and 119 may be provided respectively at the inlet 112 and the outlet 114.

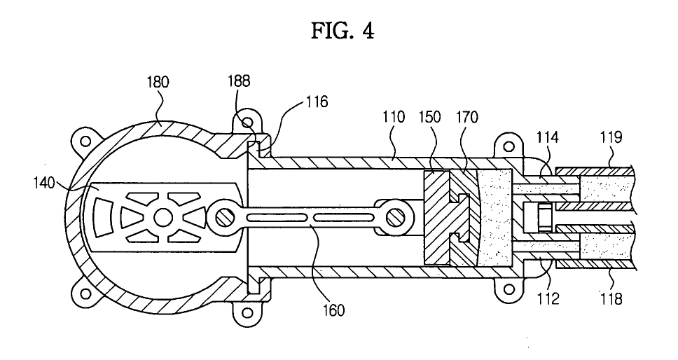

A protruding rib 116 (see FIG. 4) may be provided at the other end of the cylinder 110 and may be coupled to the case 180.

The pressure regulating unit 120 includes a motor 130, a rotating plate 140, a piston 150, and a connecting rod 160 coupled to both the rotating plate 140 and the piston 150.

The rotating plate 140 is coupled to a shaft of the motor 130 and is rotated in the case 180 by the motor 130.

Although not illustrated, a speed change device, such as a speed reducer, may be placed between the motor 130 and the rotating plate 140. When using the speed reducer, liquid detergent may be introduced into or discharged from the cylinder 110 at an increased pressure.

The rotating plate 140 is provided at one end thereof with a first hinge coupling portion 162 to be hingedly coupled to the connecting rod 160.

The piston 150 is arranged to rectilinearly reciprocate in the cylinder 110 and serves to introduce liquid detergent into the cylinder 110 or discharge the introduced liquid detergent from the cylinder 110. The piston 150 has a circular outer shape corresponding to the interior of the cylinder 110, and may have a slightly smaller diameter than an inner diameter of the cylinder 110.

The piston 150 is provided at a front surface thereof with a coupling protrusion 152. The coupling protrusion 152 protrudes forward from the front surface of the piston 150 by a predetermined length so as to be fitted into a sealing member 170.

The piston 150 is further provided at a rear surface thereof with a second hinge coupling portion 154 to be hingedly coupled to the connecting rod 160.

The sealing member 170 is fitted around the coupling protrusion 152 provided at the front surface of the piston 150.

The sealing member 170 has an approximately circular shape. The coupling protrusion 152 may be fitted into a coupling recess 174 indented in a rear surface of the sealing member 170.

The sealing member 170 is provided at an outer circumferential surface thereof with at least one protrusion 172.

A diameter of the protrusion 172 is equal to or slightly greater than the inner diameter of the cylinder 110. Thus, the protrusion 172 continuously comes into contact with an inner circumferential surface of the cylinder 110 while the piston 150 reciprocates in the cylinder 110.

Since the protrusion 172 continuously comes into contact with the inner circumferential surface of the cylinder 110, it may be possible to prevent liquid detergent received in the cylinder 110 from moving into the pressure regulating unit 120.

The sealing member 170 may be made of, e.g., synthetic rubber or polyurethane.

The connecting rod 160 has an elongated bar shape having a slightly greater length than a diameter of the rotating plate 140. One end of the connecting rod 160 is coupled to the rotating plate 140 and the other end of the connecting rod 160 is coupled to the second hinge coupling portion 154 of the piston 150.

The end of the connecting rod 160 is hingedly coupled to the first hinge coupling portion 162 provided at one end of the rotating plate 140, thereby being eccentrically rotated along a circular trajectory drawn by the first hinge coupling portion 162 during rotation of the rotating plate 140. Also, the other end of the connecting rod 160 is hingedly coupled to the second hinge coupling portion 154 of the piston 150, thereby being reciprocated in a longitudinal direction of the cylinder 110.

Accordingly, the connecting rod 160 acts to translate rotating motion of the rotating plate 140 connected to the motor 130 into rectilinear reciprocating motion of the piston 150.

The connecting rod 160 may be made of injection molded plastic, but may be made of aluminum if it is necessary to reinforce the connecting rod 160.

The case 180 serves to connect the cylinder 110 and the pressure regulating unit 120 to each other. The case 180 includes a receiving space 186 in which the pressure regulating unit 120 is received, and a receiving groove 188 for coupling of the cylinder 110.

The case 180 is provided at an outer periphery thereof with at least one fixing protrusion 182. The fixing protrusion 182 has a coupling hole 184 perforated in the center thereof.

The coupling hole 184 of the fixing protrusion 182 may serve to couple the detergent feeding apparatus 100 to the sidewall of the cabinet 120.

The motor 130 is coupled to a rear surface of the case 180 and serves to rotate the rotating plate 140.

A case cover 190 is coupled to a front surface of the case 180 and serves to prevent fine particulates, such as dust, from entering the pressure regulating unit 120 from the outside.

Hereinafter, the operating principle of the detergent feeding apparatus 100 according to the embodiment will be described.

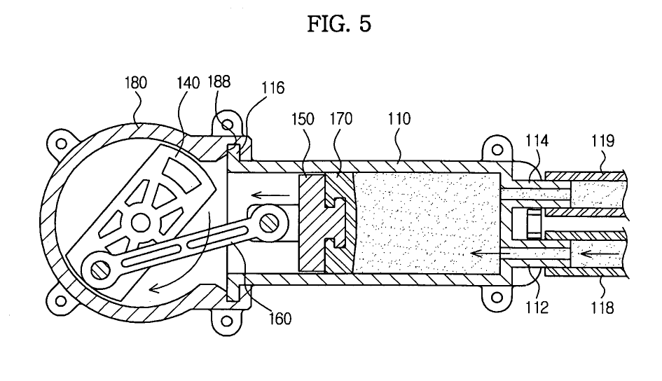

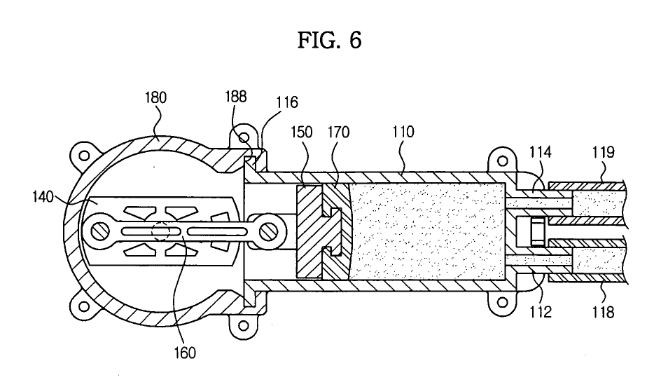

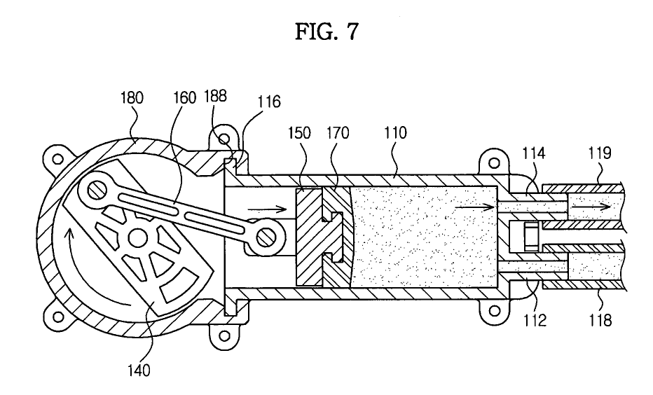

FIG. 4 is a sectional view illustrating an initial state of the detergent feeding apparatus according to the embodiment, FIG. 5 is a sectional view illustrating introduction of liquid detergent into the detergent feeding apparatus according to the embodiment, FIG. 6 is a sectional view illustrating liquid detergent completely introduced into the detergent feeding apparatus according to the embodiment, and FIG. 7 is a sectional view illustrating discharge of liquid detergent from the detergent feeding apparatus according to the embodiment.

As illustrated in FIG. 4, in the initial state of the detergent feeding apparatus 100 according to the embodiment, the connecting rod 160 and the rotating plate 140 are aligned such that the total length of the connecting rod 160 and the rotating plate 140 is maximized. In such a state, a space defined by a front end of the piston 150 and the cylinder 110 is minimized.

As illustrated in FIG. 5, if the motor 130 is rotated clockwise to rotate the rotating plate 140 coupled to the shaft of the motor 130, one end of the connecting rod 160 is eccentrically rotated and the other end of the connecting rod 160 is moved toward the pressure regulating unit 120.

The piston 150 connected to the other end of the connecting rod 160 is moved only rectilinearly by being caught by the inner circumferential surface of the cylinder 110, thereby being moved rearward toward the pressure regulating unit 120.

As the piston 150 is rectilinearly moved rearward toward the pressure regulating unit 120, the space defined by the front end of the piston 150 and the cylinder 110 is gradually increased, causing the interior pressure of the cylinder 110 to be reduced and allowing liquid detergent to be introduced from the introduction hose 84 into the cylinder 110.

In this case, the anti-backflow valve 118 provided at the introduction hose 84 is completely opened to allow the liquid detergent to be introduced from the introduction hose 84 into the cylinder 110, and the anti-backflow valve 119 provided at the discharge hose 86 is completely closed to prevent the liquid detergent from being introduced from the discharge hose 86 into the cylinder 110.

As illustrated in FIG. 6, if the motor 130 is rotated a half turn such that the connecting rod 160 and the rotating plate 140 are parallel to each other and completely overlap, the space defined by the front end of the piston 150 and the cylinder 110 is maximized and is completely filled with the liquid detergent. Thus, introduction of the liquid detergent is stopped.

As illustrated in FIG. 7, if the motor 130 is further rotated, the other end of the connecting rod 160 is moved away from the pressure regulating unit 120. As the piston 150 connected to the other end of the connecting rod 160 is also moved forward away from the pressure regulating unit 120, the space defined by the front end of the piston 150 and the cylinder 110 is gradually reduced, causing the interior pressure of the cylinder 110 to be increased and allowing the liquid detergent to be discharged from the cylinder 110 into the discharge hose 86.

In this case, the anti-backflow valve 119 provided at the discharge hose 86 is completely opened to allow the liquid detergent to be discharged from the cylinder 110 to the discharge hose 86, and the anti-backflow valve 118 provided at the introduction hose 84 is completely closed to prevent the liquid detergent from being moved from the cylinder 110 to the introduction hose 84.

If the motor 130 is rotated one turn such that the connecting rod 160 and the rotating plate 140 are again aligned as illustrated in FIG. 4, the space defined by the front end of the piston 150 and the cylinder 110 is minimized, completing discharge of the liquid detergent.

If additional liquid detergent is necessary, the above-described operation is repeated to further feed liquid detergent.

Since the detergent feeding apparatus 100 according to the embodiment has the above-described configuration to supply a fixed amount of liquid detergent per revolution of the motor 130, a required amount of liquid detergent may be supplied based on the weight of laundry as necessary. In addition, the feed amount of liquid detergent may be regulated by controlling revolutions per minute of the motor 130.

In addition, since liquid detergent, which is a non-compressive fluid, is directly introduced into or discharged from the cylinder 110, stable feeding of liquid detergent even after extended use is possible and thus, a fixed amount of liquid detergent may be fed.

Hereinafter, a detergent feeding apparatus 200 according to another embodiment will be described in detail.

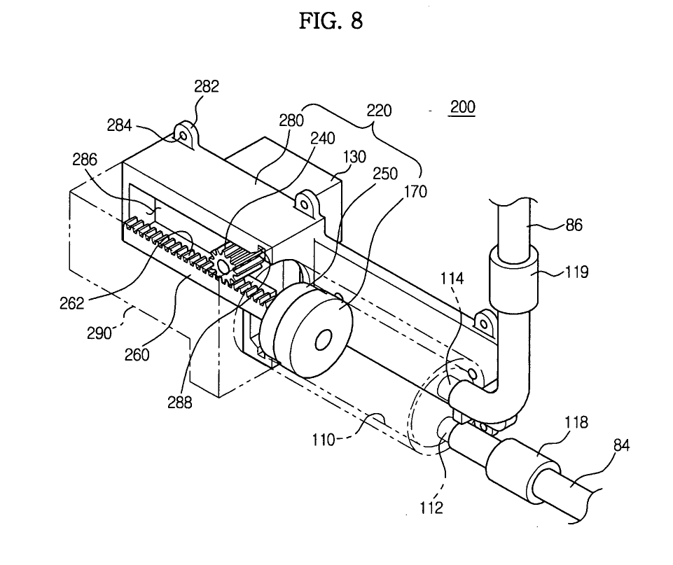

FIG. 8 is a perspective view illustrating the detergent feeding apparatus according to another embodiment.

As illustrated in FIG. 8, the detergent feeding apparatus 200 includes the cylinder 110 and a pressure regulating unit 220. The cylinder 110 and the pressure regulating unit 220 are connected to each other by a case 280.

The configuration of the cylinder 110 of the detergent feeding apparatus 200 and the connection configuration of the introduction hose 84 and the discharge hose 86 are identical to those in the detergent feeding apparatus 100 according to the above-described embodiment and thus, a description thereof will thus be omitted.

The pressure regulating unit 220 includes the motor 130, a first gear 240, a piston 250, and a second gear 260 coupled to the first gear 240 and the piston 250.

The first gear 240 is coupled to the shaft of the motor 130 so as to be rotated along with the shaft of the motor 130 and is engaged with the second gear 260.

Although not illustrated, a speed change device, for example, such as a speed reducer, may be placed between the motor 130 and the first gear 240. When using the speed reducer, liquid detergent may be introduced into or discharged from the cylinder 110 at an increased pressure.

The piston 250 is arranged to rectilinearly reciprocate in the cylinder 110 and serves to introduce liquid detergent into the cylinder 110 or discharge the introduced liquid detergent from the cylinder 110. The piston 250 has a circular outer shape corresponding to the interior of the cylinder 110, and may have a slightly smaller diameter than the inner diameter of the cylinder 110.

The sealing member 170 is coupled to a front surface of the piston 250. The configuration of the sealing member 170 and the coupling relationship between the sealing member 170 and the piston 250 are identical to those in the detergent feeding apparatus 100 according to the above-described embodiment (see FIG. 3) and a description thereof will thus be omitted.

The second gear 260 is provided at a rear surface of the piston 250.

The second gear 260 and the piston 250 may be individually fabricated and coupled to each other, or may be integrally fabricated with each other.

The second gear 260 has a bar shape and is provided at a longitudinal surface thereof with a toothed portion 262.

One end of the second gear 260 is coupled to the piston 250 and the toothed portion 262 of the second gear 260 is gear-engaged with the first gear 240.

Since the first gear 240 and the second gear 260 are engaged with each other, if the first gear 240 is rotated, the second gear 260 is rectilinearly reciprocated in a longitudinal direction of the cylinder 110 and the piston 250 connected to the second gear 260 is rectilinearly reciprocated in the cylinder 110 along with the second gear 260.

Accordingly, the second gear 260 acts to translate rotating motion of the first gear 240 connected to the motor 130 into rectilinear reciprocating motion of the piston 150.

The case 280 serves to connect the cylinder 110 and the pressure regulating unit 220 to each other, and includes a receiving space 286 in which the pressure regulating unit 220 is received, and a receiving groove 288 for coupling of the cylinder 110.

The case 280 is provided at an outer periphery thereof with at least one fixing protrusion 282. The fixing protrusion 182 has a coupling hole 284 perforated in the center thereof.

The coupling hole 284 of the fixing protrusion 282 may serve to couple the detergent feeding apparatus 200 to the sidewall of the cabinet 20.

The motor 130 is coupled to a rear surface of the case 280 and serves to rotate the first gear 240.

A case cover 290 is coupled to a front surface of the case 280 and serves to prevent fine particulates, such as dust, from entering the pressure regulating unit 220 from the outside.

In the detergent feeding apparatus 200 according to embodiment, the principle in that the piston 250 is rectilinearly reciprocated in the cylinder 110 by the first gear 240 and the second gear 260 and liquid detergent is introduced or discharged using pressure variation inside the cylinder 110 is identical to that of the detergent feeding apparatus 100 according to the above-described embodiment, and a description thereof will thus be omitted.

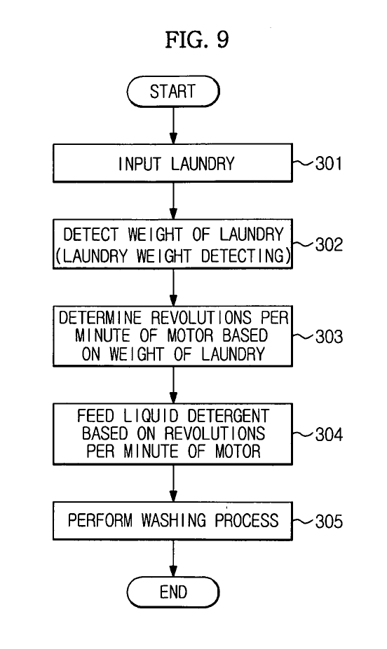

FIG. 9 is a flow chart illustrating a procedure of performing washing by determining the feed amount of liquid detergent based on the weight of laundry.

If the user inputs laundry into the drum 40, the laundry weight sensor 55 detects the weight of laundry input into the drum 40 (301 and 302).

The control device 45 determines the input amount of liquid detergent based on the weight of laundry detected by the laundry weight sensor 55, and determines revolutions per minute of the motor 130 provided at the detergent feeding apparatus 100 or 200 based on the determined input amount of liquid detergent (303).

As the motor 130 is rotated at the determined revolutions per minute of the motor 130, liquid detergent is fed into the detergent box 70 by the detergent feeding apparatus 100 or 200. The fed liquid detergent is introduced into the drum 40 after being mixed with water fed from the external water supply source in the detergent box 70 (304).

If the drum 40 is rotated in a state in which the liquid detergent is introduced into the drum 40, laundry is sequentially subjected to washing, rinsing and dehydrating processes until the laundry is completely washed (305).

As is apparent from the above description, a detergent feeding apparatus according to the embodiments may accurately fed a required amount of liquid detergent based on the amount of laundry in an automated manner.

Further, as a result of accurately feeding a required amount of liquid detergent based on the amount of laundry, it is possible to prevent damage to laundry or poor washing of laundry, resulting in enhanced washing efficiency.

Furthermore, stable feeding of an appropriate amount of liquid detergent may be possible even after extended use.

In addition, improved energy efficiency may be accomplished.

Although the embodiment has been shown and described, it would be appreciated by those skilled in the art that changes may be made in these embodiments without departing from the principles and spirit of the invention, the scope of which is defined in the claims and their equivalents.

1. A washing machine comprising:
a cabinet defining an external appearance of the washing machine;
a drum placed in the cabinet;
a detergent box connected to the drum;
a liquid detergent reservoir placed below the detergent box and to store liquid detergent therein; and
a detergent feeding apparatus connected to the detergent box and the liquid detergent reservoir and to feed the liquid detergent stored in the liquid detergent reservoir to the detergent box,
wherein the detergent feeding apparatus includes a cylinder which the liquid detergent is introduced into or discharged from, and a pressure regulating unit connected to the cylinder and to introduce the liquid detergent into the cylinder or discharge the introduced liquid detergent from the cylinder.

2. The washing machine according to claim 1, wherein the cylinder further includes an inlet connected to the liquid detergent reservoir and an outlet connected to the detergent box.

3. The washing machine according to claim 2, wherein the inlet and the liquid detergent reservoir are connected to each other using an introduction hose, and the introduction hose is provided with an anti-backflow valve.

4. The washing machine according to claim 3, wherein the outlet and the detergent box are connected to each other using a discharge hose, and the discharge hose is provided with an anti-backflow valve.

5. The washing machine according to claim 1, wherein the pressure regulating unit includes a motor, a rotating plate coupled to a shaft of the motor, a piston to rectilinearly reciprocate in the cylinder, and a connecting rod having one end coupled to the rotating plate and the other end coupled to the piston.

6. The washing machine according to claim 5, wherein a sealing member is provided at a front end of the piston to prevent the liquid detergent from entering the pressure regulating unit.

7. The washing machine according to claim 6, wherein the sealing member includes at least one protrusion to come into contact with an inner circumferential surface of the cylinder.

8. The washing machine according to claim 1, wherein the pressure regulating unit includes a motor, a first gear coupled to a shaft of the motor, a piston to rectilinearly reciprocate in the cylinder, and a second gear coupled to the piston and engaged with the first gear.

9. The washing machine according to claim 8, wherein the second gear is integrally formed with the piston.

10. The washing machine according to claim 5, further comprising:
a laundry weight sensor; and
a control device to control operation of the motor,
wherein the laundry weight sensor detects the weight of laundry introduced into the drum, and
wherein the control device determines an input amount of liquid detergent based on the weight of laundry detected by the laundry weight sensor and controls revolutions per minute of the motor based on the determined input amount of liquid detergent, so as to feed liquid detergent into the detergent box.

11. The washing machine according to claim 1, wherein the liquid detergent reservoir includes a sensor to confirm a residual amount of the liquid detergent.

12. A detergent feeding apparatus for a washing machine comprising:
a cylinder which liquid detergent is introduced into or discharged from; and
a pressure regulating unit connected to the cylinder and to introduce the liquid detergent into the cylinder or discharge the introduced liquid detergent from the cylinder,
wherein the pressure regulating unit includes a motor, a rotating plate coupled to a shaft of the motor, a piston to rectilinearly reciprocate in the cylinder and a connecting rod having one end coupled to the rotating plate and the other end coupled to the piston so as to translate rotating motion of the rotating plate into rectilinear reciprocating motion of the piston.

13. The detergent feeding apparatus according to claim 12, wherein the cylinder includes an inlet through which the liquid detergent is introduced and an outlet through which the liquid detergent is discharged.

14. The detergent feeding apparatus according to claim 13, wherein the liquid detergent is introduced into the cylinder through the inlet if the interior pressure of the cylinder is lowered by rearward movement of the piston, and is discharged from the cylinder through the outlet if the interior pressure of the cylinder is raised by forward movement of the piston.

15. The detergent feeding apparatus according to claim 14, wherein the inlet or the outlet is provided with an anti-backflow valve to allow the liquid detergent to move in one direction.

16. The detergent feeding apparatus according to claim 15, wherein a sealing member is provided at a front end of the piston to prevent the liquid detergent from entering the pressure regulating unit.

17. The detergent feeding apparatus according to claim 16, wherein the sealing member includes at least one protrusion to come into contact with an inner circumferential surface of the cylinder.

18. A detergent feeding apparatus for a washing machine comprising:
a cylinder which liquid detergent is introduced into or discharged from; and
a pressure regulating unit connected to the cylinder and to introduce the liquid detergent into the cylinder or discharge the introduced liquid detergent from the cylinder,
wherein the pressure regulating unit includes a motor, a first gear coupled to a shaft of the motor, a piston to rectilinearly reciprocate in the cylinder, and a second gear coupled to the piston and engaged with the first gear.

19. The detergent feeding apparatus according to claim 18, wherein the cylinder includes an inlet through which the liquid detergent is introduced, and an outlet through which the liquid detergent is discharged.

20. The detergent feeding apparatus according to claim 19, wherein the liquid detergent is introduced into the cylinder through the inlet if the interior pressure of the cylinder is lowered by rearward movement of the piston, and is discharged from the cylinder through the outlet if the interior pressure of the cylinder is raised by forward movement of the piston.

21. The detergent feeding apparatus according to claim 20, wherein the inlet or the outlet is provided with an anti-backflow valve to allow the liquid detergent to move in one direction.

22. The detergent feeding apparatus according to claim 21, wherein a sealing member is provided at a front end of the piston to prevent the liquid detergent from entering the pressure regulating unit.

23. The detergent feeding apparatus according to claim 22, wherein the sealing member includes at least one protrusion to come into contact with an inner circumferential surface of the cylinder.

24. The washing machine according to claim 7, further comprising:
a laundry weight sensor; and
a control device to control operation of the motor,
wherein the laundry weight sensor detects the weight of laundry introduced into the drum, and
wherein the control device determines an input amount of liquid detergent based on the weight of laundry detected by the laundry weight sensor and controls revolutions per minute of the motor based on the determined input amount of liquid detergent, so as to feed liquid detergent into the detergent box.
